(19) United States
(12) Patent Application Publication
(10) Pub. No.: US 2016/0378774 A1
(43) Pub. Date: Dec. 29, 2016

(54) Predicting Geolocation Of Users On Social Networks

(71) Applicants: Sofia Apreleva, Santa Monica, CA (US); Alejandro Cantarero, Santa Monica, CA (US); Christopher Goller, Winona, MN (US)

(72) Inventors: Sofia Apreleva, Santa Monica, CA (US); Alejandro Cantarero, Santa Monica, CA (US); Christopher Goller, Winona, MN (US)

(73) Assignee: SeaChange International, Inc., Acton, MA (US)

(21) Appl. No.: 14/747,439

(22) Filed: Jun. 23, 2015

(51) Int. Cl. G06F 17/30; H04L 29/08

(52) U.S. Cl. CPC G06F 17/3087; H04L 67/22; H04L 67/18; G06F 17/30867; G06F 17/30241; G06F 17/30598; G06F 17/30958

(57) ABSTRACT

A system and method for predicting the location of a user of social media utilizing information related to the interaction of the user with other users of the social media is described.

### BACKGROUND

This invention relates to systems and methods for assigning location information to users on social networks that do not provide any location information on their account.

A users' location is a very important contextual piece of information to pair with what a person is saying. Marketers and advertisers wish to know where to spend money and target ads. Brands want to know which regions are showing adoption. News outlets wish to find people sharing interesting local content about their market.

Previously, a user's location could be determined from information related to the user's physical address, determined, for example, through mailing lists and telephone directories, among other sources. Thus, advertising could be directed to a particular territory to reach a particular set of consumers.

With the advent of the modern World Wide Web, it became possible for users to communicate well beyond the traditional territories; indeed, it is now possible to advertise to a set of consumers that are located throughout the world. Along with the World Wide Web has come social media, which allows users to communicate with each other in a fast and viral manner. Word of mouth anecdotes concerning products and services used to be limited. Now, with social media, such anecdotes can be virally spread much faster and to a wider number of consumers.

Social media sites receive and process vast amounts of communications between its users; these communications may contain information about the location of the users, but often does not. Since the communications may be mined for data that could be useful to an advertiser, the social media companies have typically analyzed and sold information gleaned from the communications to entities wishing to reach various subsets of consumers. For this outreach to be successful, however, it is necessary to be able to assign a location to the originator of each communication.

Various techniques have been proposed to estimate the location of a user. For example, in one method, the words of the communication are analyzed to determine words used in a particular region or dialect. Another method considers the relationship between users, such as whether one user follows another user on the assumption that the relationship may reflect the regions in which the user and the follower are located. For the most part, these techniques have been successful only to the extent that the originator of the communication can be located within a wide region, such as a country or state. While even this location ability can be useful, advertisers often wish to transmit their message to much smaller regions, such as consumers located in an individual city.

What has been needed, and heretofore unavailable, is an automated system that can identify where users of social networks are located rapidly and with sufficient particularity so as to allow for narrowly targeted communications from advertisers or others who wish to reach a particular subset of consumers. The present invention satisfies this and other needs.

### SUMMARY OF THE INVENTION

In it most general aspect, the present invention includes a system and method for assigning location information to a user of a social network that does not already have a location associated with their account.

In another aspect, the present invention includes a computer implemented method for assigning location data to users, comprising: locating all users with location information on their account and assigning a location to those users; constructing a graph representation of the social network; and propagating known locations through that network to users with no known location.

In another aspect, assigning a location to a user who has provided location information may involve taking all messages with GPS tags and determining the user's most likely location from those tags.

In yet another aspect, assigning a location to the user may be taken from a self-reported location field.

In still another aspect the social graph may be constructed by looking at a user's friends on a social network.

In yet another aspect the social graph may be constructed by looking at communication patterns between users on the network.

In still another aspect, location information may be assigned to users in the network that do not already have a location via a diffusion process on the social graph.

In a further aspect, the present invention includes a computer implemented method for predicting the geolocation of users in a social network, comprising: receiving data on posts from a social network by a processor in operable communication with the social network; identifying users on the social network using information data included in the posts; identifying users with location information included in the posts and storing the location information for those users in a memory in operable communication with the processor; identifying interactions between different users on the social network using the information data included in the posts; determining an estimated location of a user whose posts do not include location information based on the user's interactions with other users on the social network; and storing the estimated location of the user in the memory.

In one alternative aspect, identifying users with location information includes identifying posts of users that contain latitude-longitude information. In another alternative aspect, identifying users with location information includes identifying users who have self-reported their location.

In still another aspect, determining an estimated location for a user from a multitude of posts from that user containing latitude-longitude coordinates includes predicting a location from the multitude of posts. In another aspect, predicting a location includes determining a median of the coordinates.

In yet another aspect, the invention further comprises determining a dispersion of the distances from the median for the coordinates. In still another aspect, the invention further comprises generating a histogram of the distances from the median for the coordinates and identifying distinct peaks in the histogram.

In still another aspect, the invention further comprises generating a sorted array of the differences of the distances between the coordinates. In another aspect, the invention further comprises analyzing the sorted array and identifying clusters of locations. In another further aspect, the invention includes determining values for a median and dispersion of each cluster.

In another aspect, interactions between users are all treated equally. In an alternative aspect, interactions between users are weighted differently depending on the type of interaction. In yet another alternative aspect, interactions between users are weighted differently depending on the frequency of interaction between the users.

In still another aspect, a subset of interactions between users are selected for use in determining an estimated location of a user whose posts do not include location information.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a flow chart illustrating an exemplary method for predicting and storing locations for users of a social network.

FIG. 2 is a flow chart illustrating an exemplary method for building a seed set of users with known locations from social media posts.

FIG. 3 is a graphic visualization of a subset of an example network from Twitter, showing where users are located and the communication patterns between them.

FIG. 4 is a flow chart depicting a method for predicting a user's location either from their posts or from their connections using a multi-modal location distribution.

FIG. 5 is a flow chart illustrating an exemplary method for generating a histogram of distances for a single user on the social network.

FIG. 6 is an exemplary map showing locations for a user with a low dispersion.

FIG. 7 is an exemplary map showing locations for a user with high dispersion, but clustered locations.

FIG. 8 is the corresponding histogram of locations for the exemplary user with high dispersion illustrated in FIG. 7.

FIG. 9 is an exemplary map showing a user with high dispersion and no clustering of their locations.

FIG. 10 is the corresponding histogram for the exemplary user with high dispersion and no clustering shown in FIG. 9.

FIG. 11 is a flow chart depicting a method for predicting a user's location either from their posts or from their connections using a clustering approach.

FIG. 12 is a flow chart illustrating an exemplary method for building and storing a graph of a user's connections on a social network.

FIG. 13 is a flow chart depicting an exemplary method for storing and accessing geo-located prediction data for a set of users.

FIG. 14 illustrates an exemplary computer system which may be programmed or configured with software commands to carry out the various embodiments of the present invention.

### DETAILED DESCRIPTION OF THE PREFERRED EMBODIMENTS

As will be described hereinafter in greater detail, the various embodiments of the present invention relate to a system and method for processing the connections between users of a social network and determining the geolocation of users in the network from those connections. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

In the following description, numerous specific details are set forth in order to provide a thorough understanding of the present invention. It will be apparent, however, to one of ordinary skill in the art, that the present invention may be practiced without these specific details. In other instances, well known components or methods have not been described in detail but rather in a block diagram, or a schematic, in order to avoid unnecessarily obscuring the present invention. Further specific numeric references such as “first driver,” may be made. However, the specific numeric reference should not be interpreted as a literal sequential order but rather interpreted that the “first driver” is different than a “second driver.” Thus, the specific details set forth are merely exemplary. The specific details may be varied from and still be contemplated to be within the spirit and scope of the present invention. The term “coupled” is defined as meaning connected either directly to the component or indirectly to the component through another component.

Throughout the description reference will be made to various software programs and hardware components that provide and carryout the features and functions of the various embodiments of the present invention.

Software programs may be embedded onto a machine-readable medium. A machine-readable medium includes any mechanism that provides, stores or transmits information in a form readable by a machine, such as, for example, a computer, server or other such device. For example, a machine-readable medium includes read only memory (ROM); random access memory (RAM); magnetic disk storage media; optical storage media; flash memory devices; digital video disc (DVD); EPROMs; EEPROMs; flash memory; magnetic or optical cards; or any type of media suitable for storing electronic instructions.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in hardware, or a combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

The term “server” is used throughout the following description. Those skilled in the art understand that a server is a computer program that provides services to other computer programs running on the same computer or processor as the server application is running, and/or other computers or processors different from the computer or processor on which the server is running. Often, the computer or processor on which the server program is running is referred to as the server, although other programs and applications may also be running on the same computer or processor. It will be understood that a server forms part of the server/client model. As such, the processor running the server program may also be a client, requesting services from other programs, and also operate as a server to provide services to other programs upon request. It is understood that the computer or processor upon which a server program is running may access other resources, such as memory, storage media, input/output devices, communication modules and the like.

Similarly, a cloud server is a server that provides shared services to various clients that access the cloud server through a network, such as a local area network and the Internet. In a cloud based system, the server is remote from the clients, and various clients share the resources of the cloud server. Information is passed to the server by the client, and returned back to the client through the network, usually the Internet.

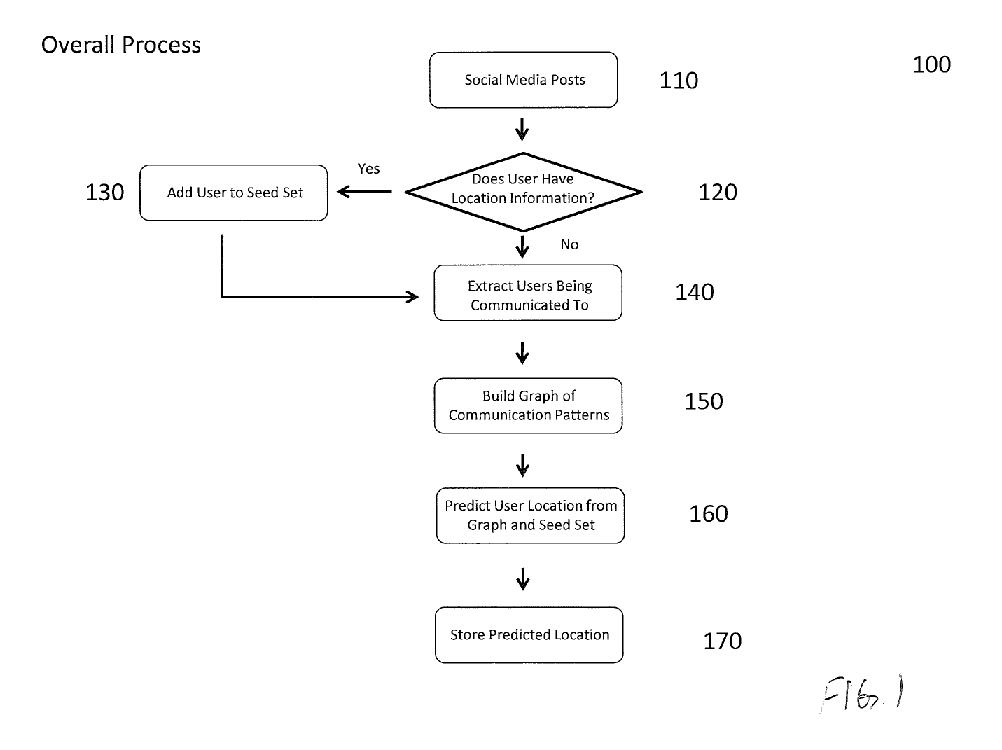

FIG. 1 is a flow chart illustrating an exemplary method 100 that may be performed by a computer system for determining the location of a user of a social network from their connections. At box 110 the system receives data from a social media network such as Twitter, Facebook, Instagram, Pinterest, Tumblr, or similar. Data may be in the form of stored text, which may include, but is not limited to, text from the social network, metadata about a post or user of a social network, voice to text recordings, electronic articles, books, or magazines, and the like. The data may be received or retrieved by a processor of the computer system from any non-transitory computer-readable medium storing textual data through a data connection such as a bus, internet connection, or any other wired or wireless means of data transfer.

At box 120, the system may check to see if the post has any location information associated with it. Location data may come in many forms, but is not limited to: a GPS tag attached to the data, a latitude and longitude coordinate, a descriptive location field such as a city name, state name or country name, a zipcode, an IP address or similar. At this time a system may normalize the location information being stored along with the textual data. For example, if the user's location information is a string “California” their data may be normalized to a latitude-longitude pair in the geographic center of the state. The system may also include a measure of confidence of the location's accuracy, such as a standard deviation. A standard deviation of 250 miles might be used to indicate the user is likely in a circle of radius 250 miles centered at the latitude-longitude pair.

At box 130, if the post has location information, the user who created the post is added to a seed set along with the location information included in the post. The seed set is stored for later use in the process to predict locations for users with no location information. These data may be stored for later retrieval in any non-transitory computer-readable medium.

At box 140, each post, whether it contained location information or not, is further processed to identify all users being communicated with in the post. Some exemplary methods of communication between users on a social network include, but are not limited to, @mentioning, liking or +1'ing the content, resharing or reposting, replying, commenting, or the lists of friends with whom an original post was shared.

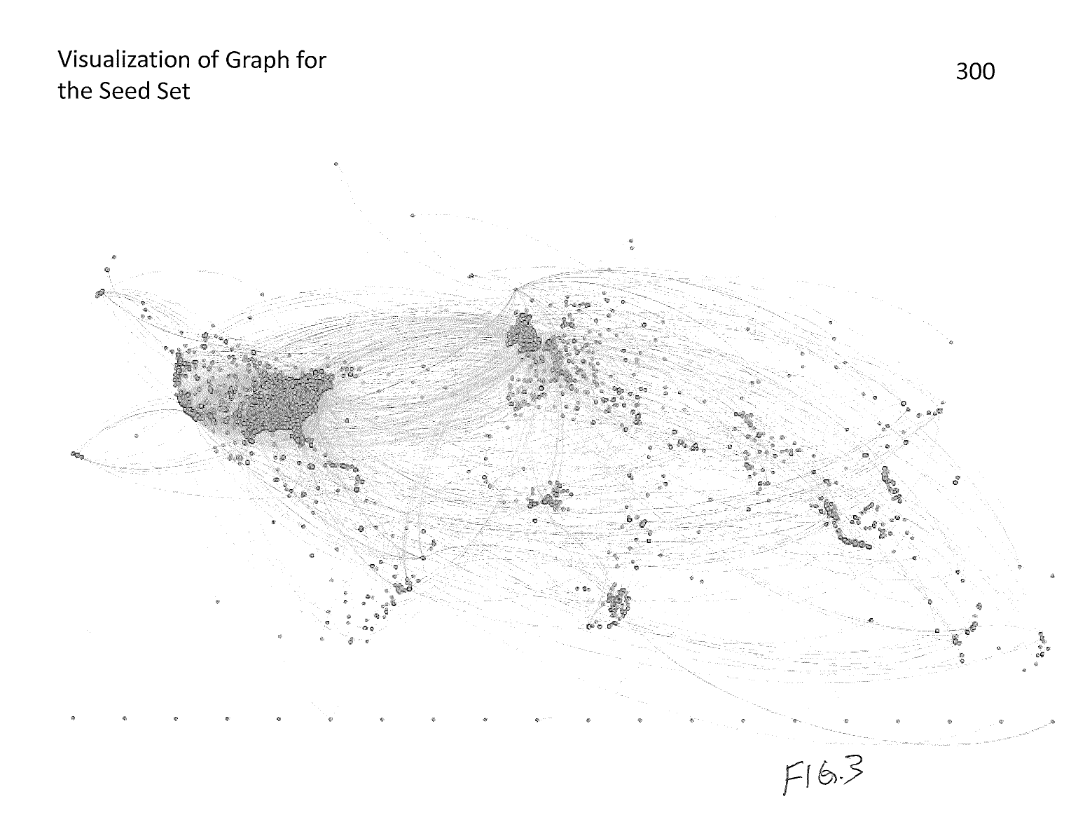

At box 150 the system may build a graph (for example, FIG. 3) of each user's connections on the social network. Connections may be built in many ways including, but not limited to: whether a user is a friend with another user, if they follower a different user, if they have sent a message to that user, or if they have liked or shared content from a user. Edges may be directional or non-directional, meaning if user A shares a post from user B, the edge may either be a directed edge from A to B (user A has interacted with user B) or there may simply be a connection between A and B (undirected). In another embodiment, edges may only be added if the communication goes both ways. For example, user A must share a post from user B and user B must share a post from user A before adding a connection to the graph. Many other options exist for how to build a graph representing the connections between users on a social network, and these will be readily apparent to one of ordinary skill in the art.

At box 160, the system may predict the locations of users in the network based on the graph built at box 150. In one embodiment, predicted locations may be made via a nearest neighbor type approach. One method to accomplish this would take each user from the seed set with a known location and assign their location to each neighbor in the graph that does not have a location. This process may continue out for any number of levels, where at each step you continue to assign location information from a current node to any neighboring node without location information. One may continue this for a fixed number of steps, N, or until the entire graph is covered, or some other suitable criteria are met. There are many possible criteria that will be readily apparent to one of ordinary skill in the art.

In the nearest neighbor approach just described, a solution for assigning a location value to a node that has more than one neighbor with location information is needed. In one embodiment, the value assigned may just be the first one reached in the iterative process and subsequent locations would be ignored. In another embodiment, the node may be assigned the average location value of all neighboring nodes with location data. In yet another embodiment, there may be preference for the level at which the neighbor was assigned a location. For example, if one neighbor has location information from the seed set (level 0) and a second has location data propagated out one level from the seed set, the level 0 location may be taken. In yet another embodiment, a weighted average of location values from different levels could be used, for example level 0 gets a weight of 0.5, level 1's weight is 0.25, level 2 receives a weight of 0.125, and so on.

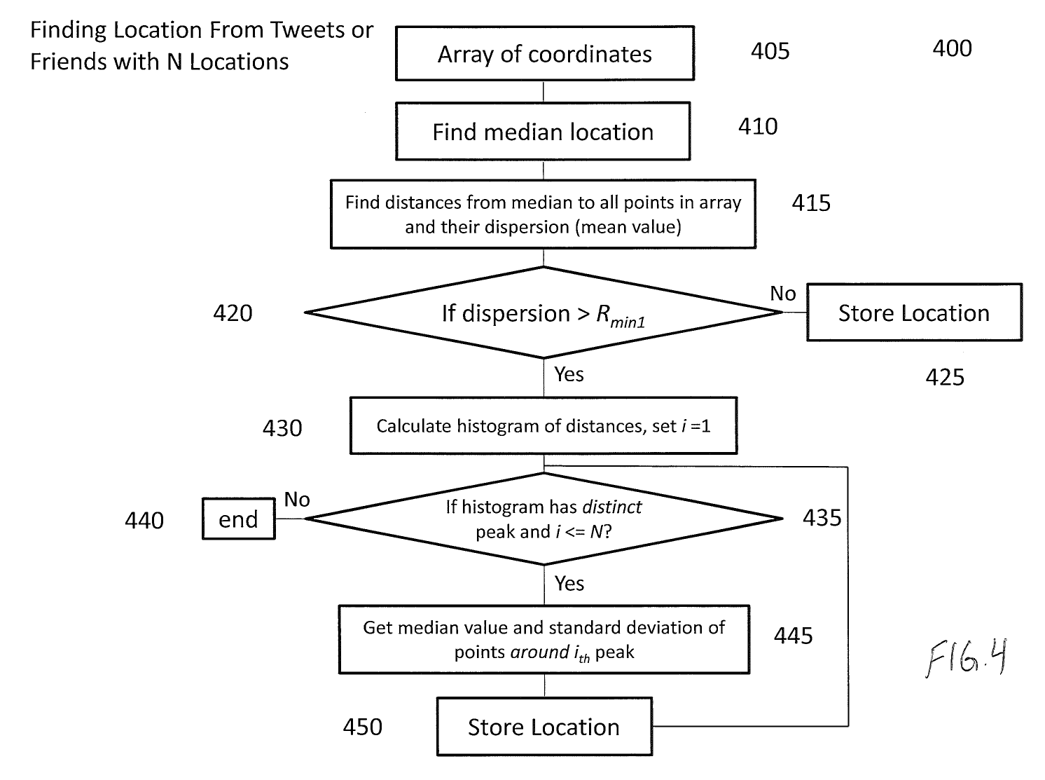

In another embodiment, locations may be made by some form of diffusion process on the graph using location information from multiple nodes to predict a location. There are many possible models that may be used to predict a single location based on the social graph. In one embodiment, the process may assume that each user has a single unique location that they may be assigned. In another embodiment, the process might assume that the user has two possible locations such as their home or their work. In yet another embodiment, no restriction may be placed on the number of locations that may be assigned to a user. In this case, location assigning may be handled through an unsupervised learning process such as a clustering method. Detailed approaches to these embodiments will be described with reference to FIGS. 4, 5 and 11. One skilled in the art will recognize that there are many approaches that can be used to assign a predicted location to a user from knowledge of their connections on the social network.

At box 170 the system may store the predicted values. Values may be stored in any non-transitory computer-readable medium.

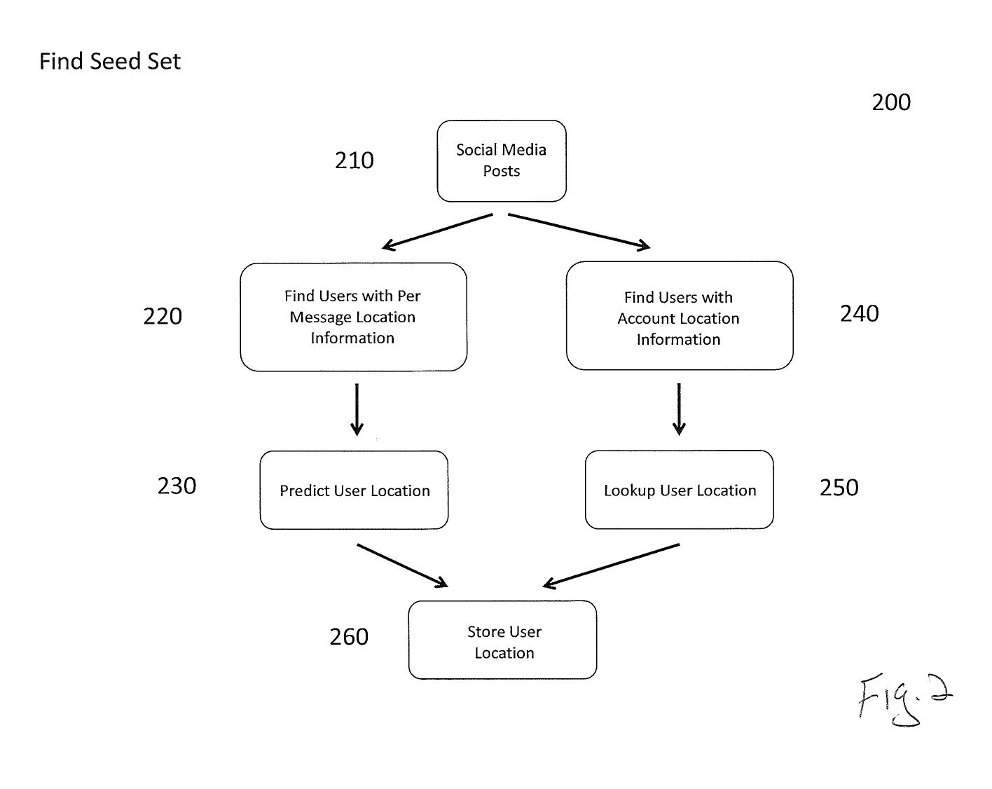

FIG. 2 is a flow chart illustrating an exemplary method 200 for finding a seed set of users in the social network that have a known location which may be conducted by a computer system having one or more processors programmed with appropriate software commands for recognizing users with location information. At box 210, the system may receive posts from a social network. Social network data may be provided by a direct data provider such as GNIP or Datasift, from the social network itself, or via an API, or a database or any other suitable method of data transmission.

At box 220, location information may be attached to each individual message. In one embodiment, this information may be provided as a latitude-longitude coordinate in the metadata describing the post. This latitude-longitude may correspond to where the message was created. In another embodiment, information on where a message was created may be provided in the form of a descriptive string, such as a named place. A named place may be, for example, a city name, region and/or country name or a specific address. In yet another embodiment, location information may also be provided as some other code that can be looked up to determine the origin of the message. One specific example of this type of identifier would be a Yahoo WOEID identifier.

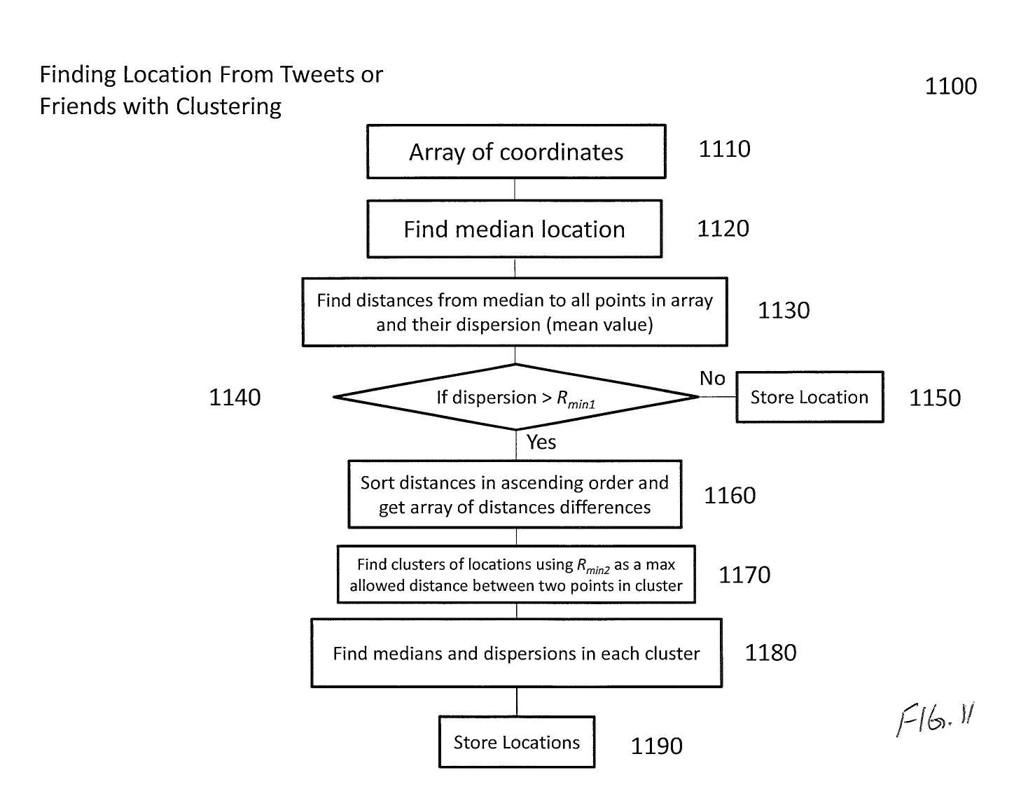

At box 230, a location for a user may be assigned from messages with location information attached to them. There are many ways this could be done which will be clear to someone skilled in the art, including using the most recent message, finding the average location, finding a median location, performing a clustering on the locations to identify multiple possible locations, building a probabilistic model of location, and others. FIGS. 4 and 11 along with their detailed descriptions below provide two possible methods for taking a set of posts belonging to a single user, each with location coordinates attached to the post, and turning these data into a single location that may be applied to the user.

Alternatively, at box 240, a user may have provided account level information about their location. This may be provided as a text level description of where they are located such as “San Francisco” or “Fresno, Calif.”. Text descriptions of a location may map exactly to a known place or may be vague and an inference may need to be made to turn the information into a known location. In a different embodiment, the account level location may be very specific, providing a text description of an exact address or a latitude and longitude coordinate.

At box 250 a user's location may need to be looked up and converted into a latitude-longitude coordinate pair. For example, a location of “San Francisco, Calif. USA” might return “37.774929, −122.419416”. In one embodiment, the lookup process may provide a unique place name. In another embodiment, the place name may not be unique or be incomplete. For example, if the place name provided were “San Francisco, Calif.”, the lookup system would need to determine that this is in the United States. In yet another embodiment only a city name may be provided such as “Santa Monica”. There are multiple cities in the world with this name, so the lookup system would need to determine the most probable location associated with this name. The most probable location may be obtained by popularity, for example, returning the city ranked the highest by an internal popularity ranking. In a different embodiment, the city with the highest population may be chosen. There are many ways to resolve conflicts that will be readily apparent to one skilled in the art.

At box 260 the user locations may be stored for later retrieval in any non-transitory computer-readable medium.

FIG. 3 shows an exemplary graph for users in the seed set described in FIG. 2. Dots are nodes in the graph, corresponding to locations of users in the seed set and the connecting lines show communication patterns between those users. The data in the chart is all users with geo-coordinates associated with their tweets from 3 days of a 0.1% random sample of all Twitter data from Jun. 12-14, 2014. Connections are for any @mention, retweet or in-reply in the tweets between users with geo-coordinates. The total dataset consists of 867,334 tweets with 442,376 unique users. The graph contains 25,808 users as nodes with location data and 9,984 communication connections between the nodes.

FIG. 4 is a flow chart for a specific method 400 for predicting the location of a user in a social network. This approach may be used to either predict the location of a single user from a collection of posts with latitude-longitude information or to predict the location of a user with no location information from their connections in the social graph.

At box 405 an array of latitude-longitude coordinates is created. In one embodiment, the location of a user may be predicted from their post history by building an array of all social media posts from that user over a fixed time period that contain latitude-longitude coordinates. In a different embodiment, the location of a user may be predicted by populating the array with the latitude-longitude coordinates of users with a direct connection to the user in the connectivity graph. In yet another embodiment, the array may be populated with latitude-longitude coordinates from users with a depth of N from the current user in the connectivity graph.

At box 410 a median location M is computed from all location elements in the array. The median may be found by sorting the latitude and longitude coordinate arrays separately and then taking the middle point in the arrays. If the number of elements in the array is even, the two middle points may be averaged.

At box 415 distances between the median computed at 410 are computed for each element in 405. Distances may be computed using standard Euclidean distance or more accurate methods that take into account the shape of the Earth's surface such as a great-circle distance measuring the distance between two points on the surface of a sphere, or the Vicenty distance (a more accurate ellipsoidal distance measurement). Using the great circle distance, distances from the median are calculated as follows:

Let (φ_{M}, λ_{M}) be the latitude and longitude of the median point and (φ₁, λ₁) be the latitude and longitude of a location. The distance is then calculated as:

$$Equ . 1 \text{:} Δφ = {φ}_{M} - {φ}_{1}$$

$$Equ . 2 \text{:} Δλ = {λ}_{M} - {λ}_{1}$$

$$Equ . 3 \text{:}$$

$$Δσ = 2 arcsin \sqrt{{sin}^{2} ( \frac{Δφ}{2} ) + cos {φ}_{1} cos {φ}_{M} {sin}^{2} ( \frac{Δλ}{2} )}$$

$$Equ . 4 \text{:} d = r Δ σ$$

with d being the final computed distance between the two points. From these distances a dispersion measure is computed to measure how widely spread out the data is. In an exemplary embodiment the dispersion may be calculated as the standard deviation of distances from each coordinate to the mean of all the coordinates:

$$Equ . 5 \text{:} D = \sqrt{\frac{1}{N} {\sum }_{i = 1}^{N} {( {x}_{i} - μ )}^{2}}$$

where μ is the mean,

$$μ = \frac{1}{N} {\sum }_{i = 1}^{N} {x}_{i}$$

and the xᵢ are the distances from the median computed above. The dispersion measurement provides some confidence as to the accuracy of the resulting prediction. If the dispersion is less than a threshold, D<τ, the median location is stored as the predicted location for the user at box 425.

If the dispersion computed at box 420 is larger than the set threshold, Rmin1, a value that is chosen empirically from the type of data being analyzed, then a histogram of distances (box 415) is constructed at box 430. At box 435 the histogram may be checked for a distinct peak. A distinct peak may be determined by finding the maximum value of the histogram. The height of this bucket in the histogram may then be compared against its immediate neighbors and a relative difference may be calculated. If that relative difference is greater than a threshold, then the histogram bucket may be labeled as a peak. It will be clear to one skilled in the art that there are many ways to identify a peak in a histogram.

If no peak is found at box 435, the prediction process exits at box 440 and no predicted location is assigned to the user. In this case, the data available to predict a location for a social network user is too spread out to be able to make an accurate prediction.

If a distinct peak was identified at box 435, the system may find a median and standard deviation value for points around the current peak. In one embodiment, points around the peak may be found by taking a fixed bucket size around the peak in the histogram and subsequently taking the points in those buckets and using them for further calculation. In another embodiment the width of the peak may be determined by looking at the relative heights of the nearby buckets to the identified peak. All buckets below a fixed threshold may then be chosen for use at box 445. In yet another embodiment, the process may search for an inflection point in a curve fitted to the maximum values of the histogram. All histogram buckets between the points of inflection may then be used at box 445. In yet another embodiment, the histogram may not be used at all and the system may go back to the actual map data and use points within a certain radius of the identified peak. It will be readily apparent to one skilled in the art that there are many approaches that may be used to identify points around the peak.

At box 450 the computed values from box 445 are stored as the predicted location for the user. These data may be stored in any reasonable manner for later retrieval on any non-transitory computer-readable medium. After storing the location, the process repeats the steps from boxes 435 and 445 any number of times. For each user in the social network graph, the system will then store zero (if the dispersion is too high or there are no distinct peaks) up to any specified number of predicted locations per user in the network.

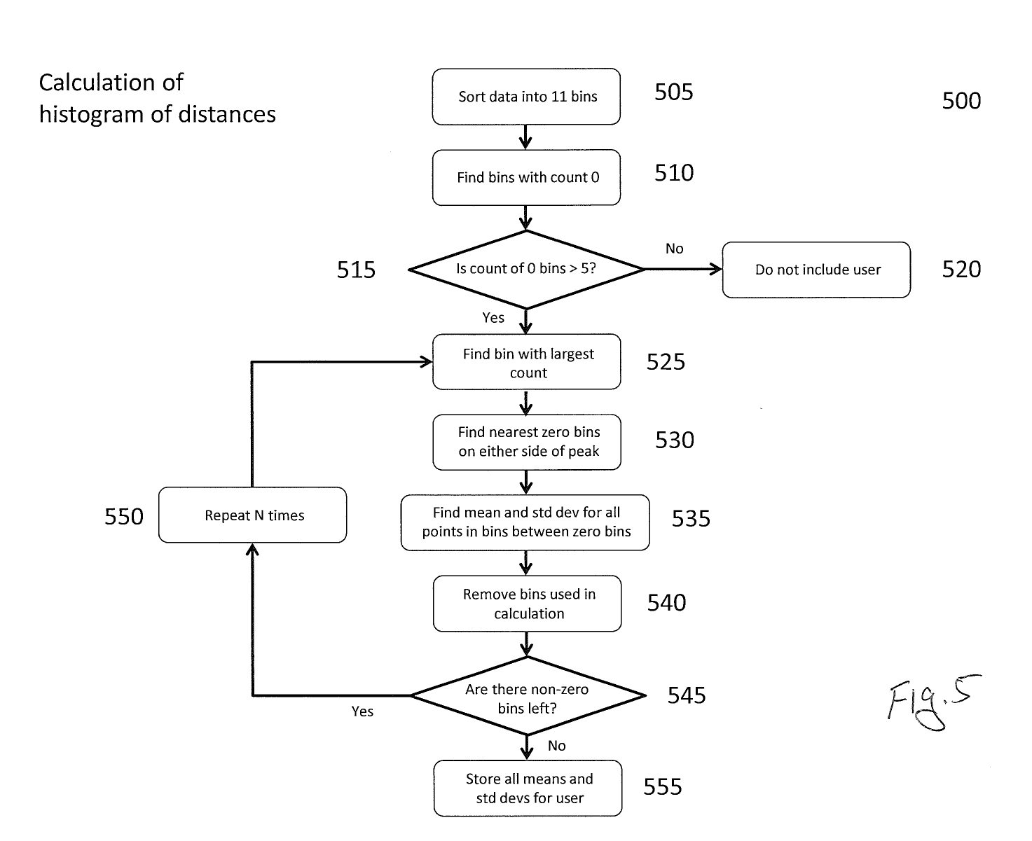

FIG. 5 shows in more detail an exemplary method 500 for computing the histogram of distances at 430 as well as the process of finding peaks in the histogram 435, and predicting the user's location 445. In this method, we start by sorting the array of distances at Box 415 into 11 distinct bins at box 505. Those skilled in the art will understand that the number of bins chosen for the analysis is empirically determined based on the number of data points available, as well as the type of data being analyzed, and that the number of bins chosen can vary accordingly without departing from the intended scope of the invention.

At box 510 the method may label all bins with a count of zero. Then at box 515 the method counts the number of bins with these zero labels. If this number is greater than 5 then a location for the user is not predicted. Recall that at box 420 the data has already been checked for a high dispersion. A high dispersion with many zeros in the histogram indicates that the users' locations are too spread out to get an accurate estimate of location. If the number of zero bins is less than or equal to five, the method may continue to find a predicted location.

At box 525 the method may identify the bin with the largest count. At box 530 the method then looks for nearest bins with count 0 on both sides of the bin with the largest peak. If no zero bins are found, then all bins up to the end of the histogram are used. At box 535, the method takes all bins between the two identified zero bins on either side of the peak (or all the way to the end of the histogram if no zero bin was found on either side). From all the points in these bins, the mean and standard deviation are computed.

At box 540, the method may mark all bins used in the calculation at box 535 as having been used. At box 545 the method may then check to see if there are any non-zero bins left that have not been previously used in a calculation. If there are, then steps from box 525 to 545 may be repeated up to either N times at box 550 or when there are no remaining non-zero bins that have not been previously used to compute a mean and standard deviation around a peak.

At box 555, when there are no further unprocessed non-zero bins, the method may take the set of all means and standard deviations computed at 535 and store them as the N predicted locations for the user in any non-transitory computer-readable medium.

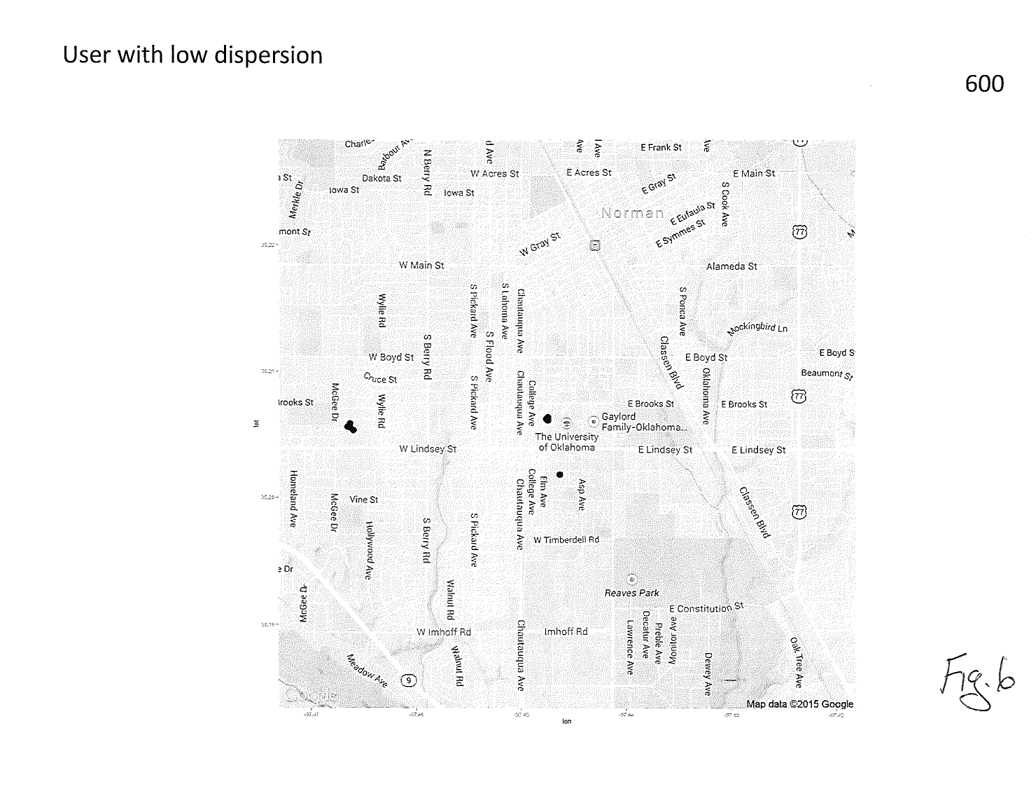

FIG. 6 shows an exemplary map with social media post data for a user with low dispersions. Locations of social media posts are marked with dots. Note that all posts fall within the boundaries of a city.

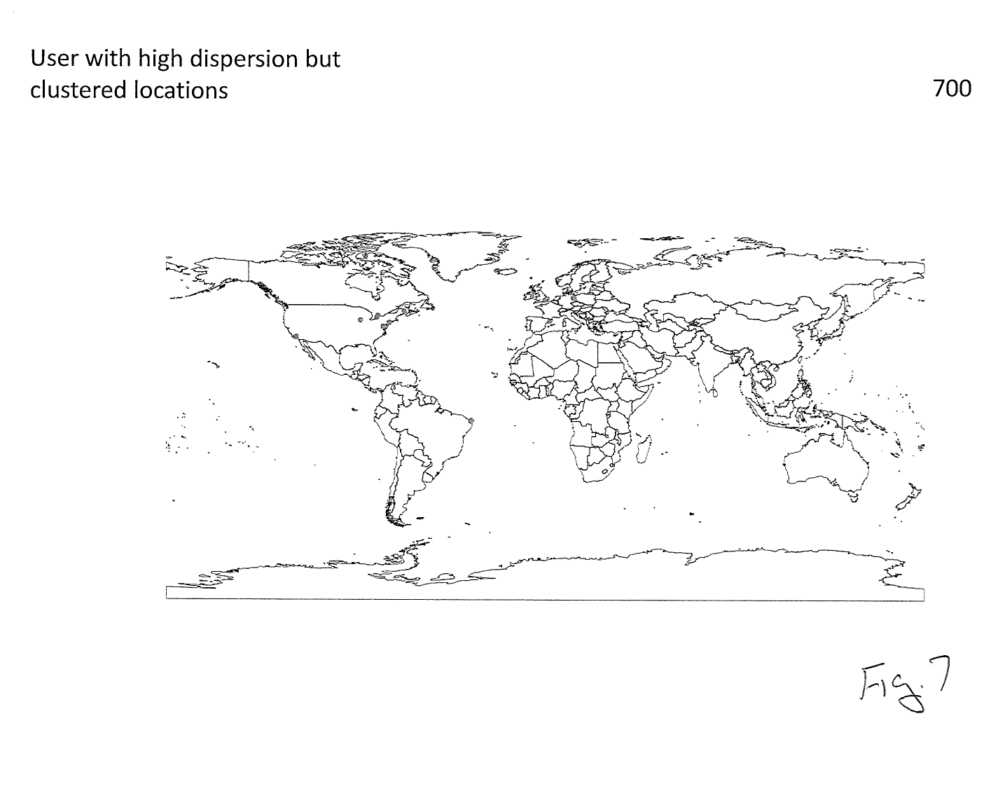

FIG. 7 shows map data for social media posts with geolocation information for an exemplary user with high dispersion, but clustered locations. Posts are marked on the map with dots. Note that there are clusters of points in the northeastern United States as well as western Europe.

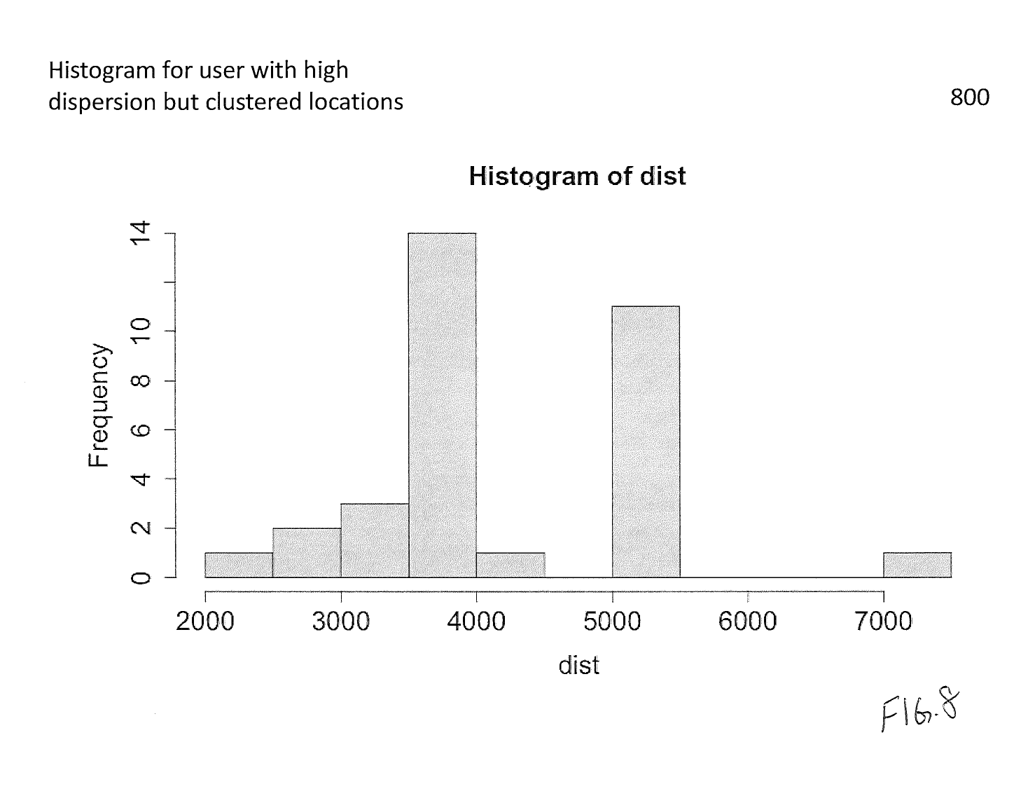

FIG. 8 depicts a histogram of distances for the same exemplary user in FIG. 7 with high dispersion but clustered locations. Note that the histogram has three distinct peaks in the fourth, seventh, and last buckets. It may be further noted that each peak is separated by zero bins and there are four zero bins total. The method described in 500 would then be able to identify up to 3 distinct locations that may be associated with this user.

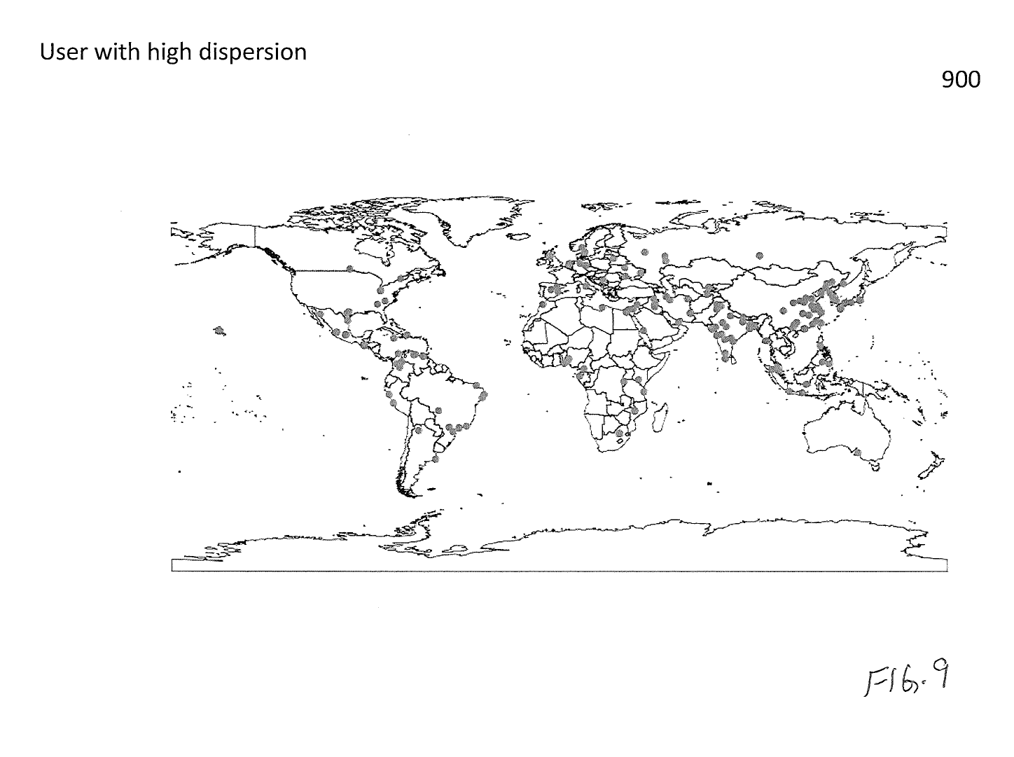

FIG. 9 shows the locations of social media posts for an exemplary user with high dispersion and no clustering. Note that the posts, represented by dots on the map are very equally spread out across the world. For such a user, a location cannot be predicted.

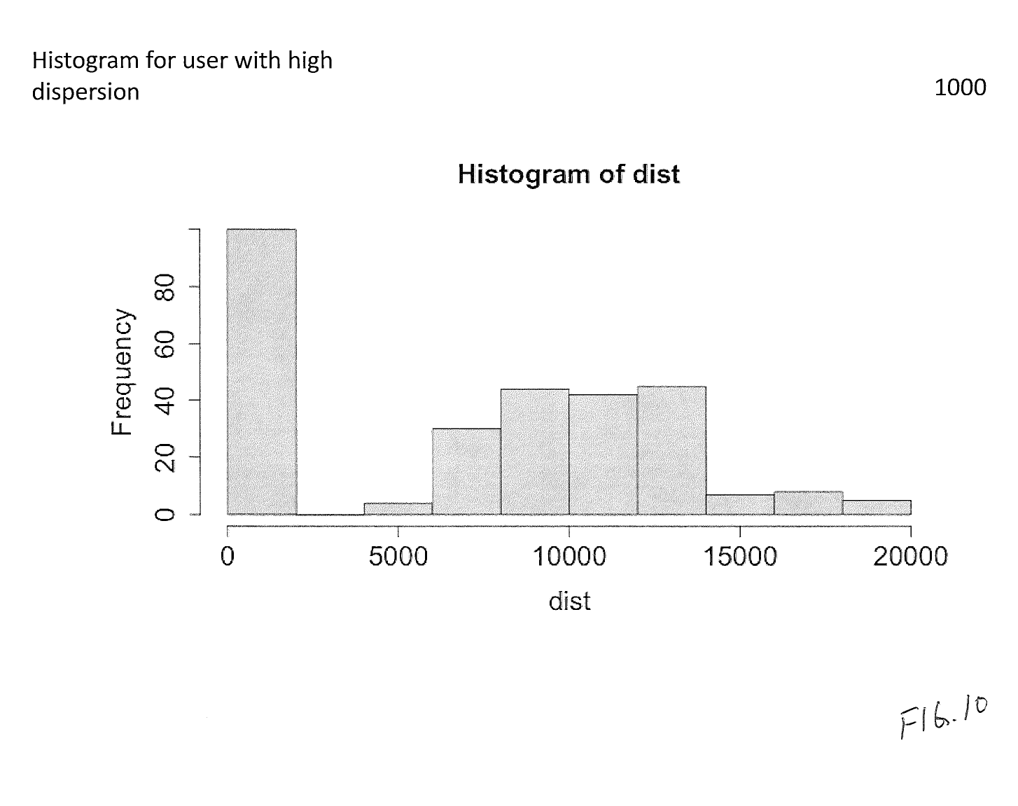

FIG. 10 shows the associated histogram of distances for the exemplary user in FIG. 9. Observe that there are very few (in this case only 1) zero bin and distances are more evenly distributed around the histogram.

The exemplary method 400 for predicting a social media user's location illustrated in FIG. 4 may be further explained with the following example. Consider the following set of data points at box 405:

### Latitude

[53.341786, 53.34179, 53.341775, 53.341779, 53.341794, 53.341783, 53.341787, 53.344091, 53.341779, 53.341778, 53.341788, 53.341787, 53.341782, 53.341774, 53.341783, 53.341778, 53.341775, 53.341533, 53.341776, 53.458302, 53.458248, 53.458277, 53.458288, 53.45829, 53.328739, 53.458307, 53.458295, 53.341777, 53.341777, 53.341795, 53.34178, 53.346791, 53.443511, 53.341762, 53.34167, 53.341671, 53.458286, 53.458236, 53.34179, 53.341788, 53.458234, 53.341783, 53.341787, 53.454153, 53.341805, 53.3418, 53.349326, 53.33497, 53.334776, −42.902384, −42.902392, −37.821301, −37.773873, −37.871089, −37.815733, −37.814108, −37.805435, −37.817765, −37.720199, −37.821982, −37.668413, −37.821953]

### Longitude

[−6.246119, −6.246179, −6.246116, −6.246148, −6.246155, −6.246153, −6.246189, −6.239531, −6.2461400000000005, −6.246126, −6.24617, −6.246136, −6.246116, −6.24615, −6.246149, −6.2461269999999995, −6.2461269999999995, −6.245879, −6.246138, −6.222826, −6.222721, −6.222806, −6.222809, −6.222817, −6.228785, −6.222832, −6.222824, −6.246136, −6.246131, −6.24616, −6.246145, −6.255272, −6.211302, −6.246129, −6.245249, −6.24525, −6.222798, −6.222735, −6.246115, −6.246145, −6.222723, −6.246147, −6.246168, −6.219317, −6.246175, −6.246117, −6.255029, −6.229036, −6.227155, 147.337633, 147.337351, 144.964147, 144.971285, 144.976182, 144.979634, 144.97527, 144.948881, 144.969723, 144.799552, 144.969024, 144.845987, 144.969504]

At box 410 the median of these arrays is computed, which is calculated as: Median longitude −6.245565; Median latitude 53.34178.

At box 415 the distances from the median are computed from each point using the Greater-circle distance function. Distances are given in kilometers.

[3.685750e−02, 4.085332e−02, 3.666000e−02, 3.878135e−02, 3.927261e−02, 3.911365e−02, 4.151103e−02, 4.763583e−01, 3.824966e−02, 3.732003e−02, 4.025042e−02, 3.798903e−02, 3.665409e−02, 3.892144e−02, 3.884781e−02, 3.738649e−02, 3.739097e−02, 3.462760e−02, 3.812015e−02, 1.305856e+01, 1.305340e+01, 1.305595e+01, 1.305714e+01, 1.305730e+01, 1.830810e+00, 1.305907e+01, 1.305780e+01, 3.798577e−02, 3.765348e−02, 3.960892e−02, 3.858148e−02, 8.527908e−01, 1.155068e+01, 3.757751e−02, 2.433876e−02, 2.422506e−02, 1.305701e+01, 1.305196e+01, 3.660117e−02, 3.858919e−02, 1.305183e+01, 3.871489e−02, 4.011551e−02, 1.262993e+01, 4.066304e−02, 3.678123e−02, 1.049310e+00, 1.334842e+00, 1.450987e+00, 1.777573e+04, 1.777572e+04, 1.723841e+04, 1.723495e+04, 1.724321e+04, 1.723887e+04, 1.723848e+04, 1.723620e+04, 1.723845e+04, 1.722033e+04, 1.723875e+04, 1.721884e+04, 1.723878e+04]

The dispersion is computed at box 420 as the standard deviation of these distances from the mean value, R=3633.865.

At box 430, the histogram of the distances is calculated to be: 49 0 0 0 0 0 0 0 13

Finally, two peaks are identified in the histogram at the first and last bins during the loop at boxes 435 and 445. The median value and standard deviations found by the calculations in method 500 are:

1) The median longitude for points in the 1 peak (first bin) is −6.246126.
2) The median latitude for points in the 1 peak is 53.34179.
3) The standard deviation for points in the 1 peak (km) is 3.307224.
4) The median longitude for points in the 2 peak (last bin) is 144.969700.
5) The median latitude for points in the 2 peak is −37.81777.
6) The standard deviation for points in the 2 peak (km) is 96.589484.

FIG. 11 is a flow chart illustrating another embodiment 1100 of a method for assigning locations to users in the social network based on either location data associated with their posts or location data associated with their connections in the social network. As in FIG. 4, method 1100 first builds an array of coordinates at box 1110. These coordinates may be from posts belonging to a single user, or be coordinates assigned to connections of varying distance to the user in the social connectivity graph as described previously.

At box 1120 a median location is found for the points in the array 1110. The distances between the median and all points in 1110 are computed at box 1130. The dispersion is computed at box 1130 as the standard deviation from the mean value of the differences in distances.

At box 1140 the dispersion is compared against a threshold. If the dispersion is less than the threshold the location is stored at box 1150 in any non-transitory computer-readable medium as the predicted location for the user. If the dispersion is greater than the threshold, then the array of distances 1130 is sorted at box 1160 in ascending order using any appropriate sorting algorithm such as bubble sort, merge sort, or quicksort. At box 1160 the system may also build an array of differences between the distances.

At box 1170 the system may set a minimum distance Rmin allowed inside the array. A first cluster may be created and the first point in the array may be added to that cluster. For each point in the array, the system may check to see if the distance between the point and the current cluster is less than Rmin. If it is, the point may be added to the current cluster. If it is not, a new cluster may be created and the point may be added to that cluster. The new cluster is then set to being the current cluster.

At box 1180 the median and dispersion may be computed for each cluster. At box 1190 the medians and dispersions of each cluster may be stored in any non-transitory computer-readable medium.

The steps for exemplary method 1100 may be further illustrated with an example. At box 1110, consider the following example arrays of location data:

### Latitude

[53.341786, 53.34179, 53.341775, 53.341779, 53.341794, 53.341783, 53.341787, 53.344091, 53.341779, 53.341778, 53.341788, 53.341787, 53.341782, 53.341774, 53.341783, 53.341778, 53.341775, 53.341533, 53.341776, 53.458302, 53.458248, 53.458277, 53.458288, 53.45829, 53.328739, 53.458307, 53.458295, 53.341777, 53.341777, 53.341795, 53.34178, 53.346791, 53.443511, 53.341762, 53.34167, 53.341671, 53.458286, 53.458236, 53.34179, 53.341788, 53.458234, 53.341783, 53.341787, 53.454153, 53.341805, 53.3418, 53.349326, 53.33497, 53.334776, −42.902384, −42.902392, −37.821301, −37.773873, −37.871089, −37.815733, −37.814108, −37.805435, −37.817765, −37.720199, −37.821982, −37.668413, −37.821953]

### Longitude

[−6.246119, −6.246179, −6.246116, −6.246148, −6.246155, −6.246153, −6.246189, −6.239531, −6.2461400000000005, −6.246126, −6.24617, −6.246136, −6.246116, −6.24615, −6.246149, −6.2461269999999995, −6.2461269999999995, −6.245879, −6.246138, −6.222826, −6.222721, −6.222806, −6.222809, −6.222817, −6.228785, −6.222832, −6.222824, −6.246136, −6.246131, −6.24616, −6.246145, −6.255272, −6.211302, −6.246129, −6.245249, −6.24525, −6.222798, −6.222735, −6.246115, −6.246145, −6.222723, −6.246147, −6.246168, −6.219317, −6.246175, −6.246117, −6.255029, −6.229036, −6.227155, 147.337633, 147.337351, 144.964147, 144.971285, 144.976182, 144.979634, 144.97527, 144.948881, 144.969723, 144.799552, 144.969024, 144.845987, 144.969504]

At box 1120 the median of these arrays is computed yielding: Median longitude −6.245565; Median latitude 53.34178.

The next step in method 1100 is to compute the distances from the median to all points in the array using the great-circle distance measurement as well as the standard deviation from the mean value for the dispersion.

Distances from Median to all Points (Km)
[3.685750e−02, 4.085332e−02, 3.666000e−02, 3.878135e−02, 3.927261e−02, 3.911365e−02, 4.151103e−02, 4.763583e−01, 3.824966e−02, 3.732003e−02, 4.025042e−02, 3.798903e−02, 3.665409e−02, 3.892144e−02, 3.884781e−02, 3.738649e−02, 3.739097e−02, 3.462760e−02, 3.812015e−02, 1.305856e+01, 1.305340e+01, 1.305595e+01, 1.305714e+01, 1.305730e+01, 1.830810e+00, 1.305907e+01, 1.305780e+01, 3.798577e−02, 3.765348e−02, 3.960892e−02, 3.858148e−02, 8.527908e−01, 1.155068e+01, 3.757751e−02, 2.433876e−02, 2.422506e−02, 1.305701e+01, 1.305196e+01, 3.660117e−02, 3.858919e−02, 1.305183e+01, 3.871489e−02, 4.011551e−02, 1.262993e+01, 4.066304e−02, 3.678123e−02, 1.049310e+00, 1.334842e+00, 1.450987e+00, 1.777573e+04, 1.777572e+04, 1.723841e+04, 1.723495e+04, 1.724321e+04, 1.723887e+04, 1.723848e+04, 1.723620e+04, 1.723845e+04, 1.722033e+04, 1.723875e+04, 1.721884e+04, 1.723878e+04]

### Dispersion: 3633.865

Next, the differences of distances are sorted at box 1160

[1.13600702e−04, 1.02802264e−02, 1.97190851e−03, 5.28757492e−05, 5.91398075e−06, 1.21127882e−04, 7.62065875e−05, 4.62142976e−04, 6.64039073e−05, 4.47197297e−06, 1.86379111e−04, 7.59160080e−05, 3.32009797e−04, 3.25496006e−06, 1.31011172e−04, 1.29398909e−04, 3.31545395e−04, 7.69774568e−06, 1.25593190e−04, 6.64072787e−05, 6.64036478e−05, 7.35679091e−05, 1.92053988e−04, 1.58824681e−04, 3.36028964e−04, 5.06165807e−04, 1.34793838e−04, 4.12276510e−04, 1.90120645e−04, 6.57159841e−04, 4.34483095e−01, 3.76117177e−01, 1.96354981e−01, 2.85292660e−01, 1.16047875e−01, 3.79504407e−01, 9.71172506e+00, 1.07834796e+00, 4.21552548e−01, 1.28534149e−04, 1.43347008e−03, 2.55031794e−03, 1.05568141e−03, 1.36555916e−04, 1.59601318e−04, 4.98726039e−04, 7.58022193e−04, 5.06417801e−04, 1.71913658e+04, 1.48652495e+00, 1.46090894e+01, 1.25487548e+00, 2.20705123e+00, 4.19231639e−02, 3.02097648e−02, 2.73595429e−01, 2.61625145e−02, 9.27536252e−02, 4.32616149e+00, 5.32064032e+02, 1.70029880e−02]

Next clusters of the locations are determined, where the values in the lists below are the indices into the longitude and latitude arrays; note that three clusters were found.

{0: {u′indices′: [35, 34, 17, 38, 12, 2, 45, 0, 9, 15, 16, 33, 28, 27, 11, 18, 8, 30, 39, 41, 3, 14, 13, 5, 4, 29, 42, 10, 44, 1, 6, 7, 31, 46, 47, 48, 24, 32, 43, 40, 37, 20, 21, 36, 22, 23, 26, 19, 25]}, 1: {u′indices′: [60, 58, 52, 56, 51, 57, 55, 59, 61, 54, 53]}, 2: {u′indices′: [50, 49]}}

Finally, the mean and standard deviation for each cluster are computed at box 1180.

1) The mean latitude for points in the 1 cluster is 3.341786999999997.
2) The mean longitude for points in the 1 cluster is −6.24612600000000035.
3) The standard deviation for points in the 1 cluster (km) is 13044544063996639.
4) The mean latitude for points in the 2 cluster is −37.815733000000002.
5) The mean longitude for points in the 2 cluster is 144.969504.
6) The standard deviation for points in the 2 cluster (km) is 4.9821871851313979.
7) The mean latitude for points in the 3 cluster is −42.902388000000002.
8) The mean longitude for points in the 3 cluster is 147.337492.
9) The standard deviation for points in the 3 cluster (km) is 0.011496565440302454.

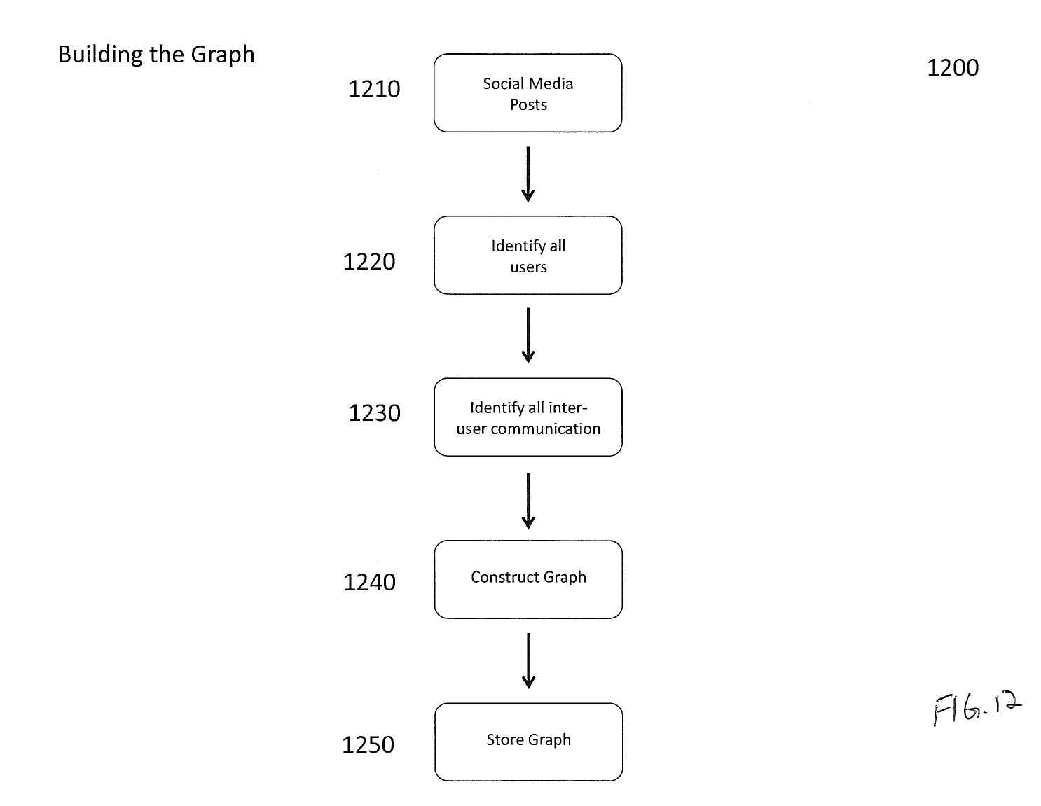

FIG. 12 is exemplary method 1200 of building a connectivity graph for a social network. At box 1210 posts from a social network are received. At box 1220 all users in the post are identified. In one embodiment the post may have the poster's name or a unique identifier associated with it. In another embodiment, a user may be re-sharing or liking a post from a different user. In this case, the metadata in the stream of social media posts may have additional data on the original post which may be used to infer a connection. In yet another embodiment, a user may be mentioning or sending the message to other users through a mechanism made available on the social network. On Twitter, this is done by @mention-ing another user, for example “hey @user123, I like what you said”. In this case, we can identify that the user who sent the message is communicating to user123. All users involved in the communication defined in the post are recorded and added as nodes to the graph.

At box 1230 the system may record the methods of the interactions between users identified at box 1220. For example, the method of communication between user A and B may be a ‘like’ or ‘share’ on Facebook. On Twitter it may be an ‘@-mention’, a ‘retweet’, or an ‘in-reply’. On other social networks it may be something similar or there may be other unique ways of sharing. Communications on a social network may also be identified as single directional or bi-directional. For example, if user A in-replies to a message from user B, the system may identify this as a bi-directional connection between A and B, or as a 1-way communication from A to B. In one embodiment all connections may be bi-directional. In another embodiment, connections at box 1230 may be 1-way. In yet another embodiment, connections may only be created when 1-way communications are created in both directions. That is, user A sends a message to user B and user B also sends a message to user A. There are many different methods for defining connections based on communication patterns on the network that will be readily apparent to one skilled in the art.

At box 1240, the social connectivity graph is constructed from the users identified at box 1220 and from the communications identified at box 1230. The users may be labeled as nodes in the graph and the communications identified may be added as edges between the nodes. The graph may be stored at box 1250 in any non-transitory computer-readable medium.

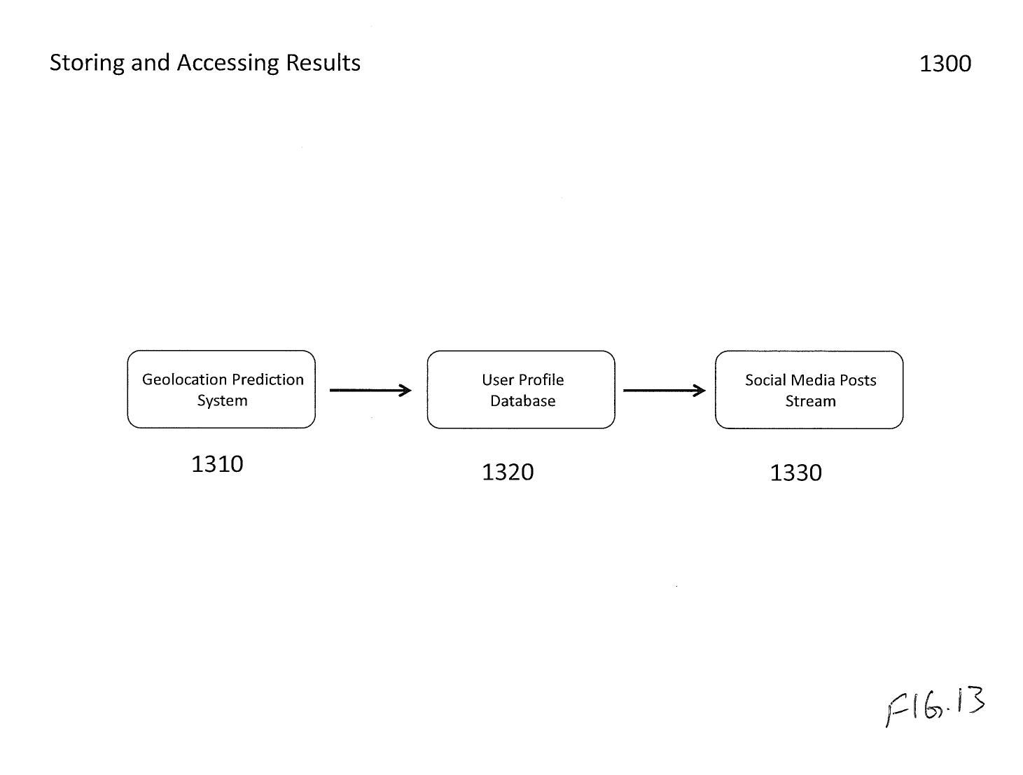

FIG. 13 is an exemplary method for running system 100 and storing the results for later retrieval. At box 1310 the geolocation prediction system described above is run. The results of the prediction are then stored in a suitable user profile database at 1320. The database may be any suitable type of database such as SQL or no-SQL including by not limited to Riak, REDIS, Cassandra, Mongo, CouchDB, or any other suitable database system. At box 1330, a stream of social media posts is received and annotated with the predicted user location by looking up users in the user profile database 1320.

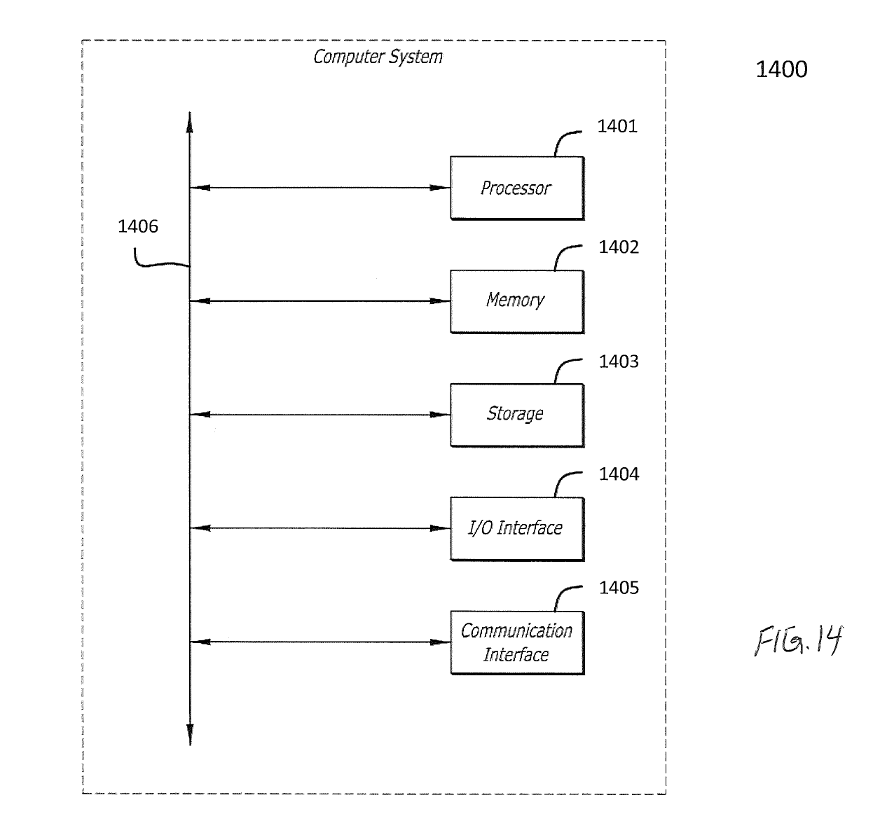

FIG. 14 illustrates an exemplary computer system 1400 which may be programmed or configured with software commands to carry out the various embodiments of the present invention. Computer system 1400 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. Computer system 1400 may also be a combination of multiple forms. Computer system 1400 may include one or more computer systems 1400, be unitary or distributed, span multiple locations, span multiple systems, or reside in a cloud (which may include one or more cloud components in one or more networks).

In an embodiment, computer system 1400 may include one or more processors 1401, memory 1402, storage 1403, an input/output (I/O) interface 1404, a communication interface 1405, and a bus 1406. Although this disclosure describes and illustrates a particular computer system having a particular number of particular components in one particular arrangement, this disclosure contemplates other forms of computer systems having any suitable number of components in any suitable arrangement.

In one embodiment, processor 1401 includes hardware for executing instructions, such as those produced by software programs. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 1401 may retrieve the instructions from an internal register, an internal cache, memory 1402 or storage 1403; decode and execute them; and then write one or more results to an internal register, an internal cache, memory 1402, or storage 1403. In one embodiment, processor 1401 may include one or more internal caches for data, instructions, or addresses. Memory 1402 may be random access memory (RAM), static RAM, dynamic RAM or any other suitable memory. Storage 1403 may be a hard drive, a floppy disk drive, flash memory, an optical disk, magnetic tape, or any other form of storage device that can store data (including instructions for execution by a processor).

In a typical embodiment, storage 1403 may be mass storage for data or instructions which may include, but is not limited to, a HDD, solid state drive, disk drive, flash memory, optical disc (such as a DVD, CD, Blue ray, and the like), magneto optical disc, magnetic tape, or any other hardware device which stores may store computer readable media, data and/or combinations thereof. Storage 1403 maybe be internal or external to computer system 1400 and may be located remotely from computer system 1400, but in communication with computer system 1400, or accessible by computer system 1400.

In another embodiment, input/output (I/O) interface 1404 includes hardware, software, or both, for providing one or more interfaces for communication between computer system 1400 and one or more I/O devices. Computer system 1400 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, and the like.

In still another embodiment, a communication interface 1405 includes hardware, software, or both which provides one or more interfaces for communication between one or more computer systems or one or more networks. Communication interface 1405 may include a network interface controller (NIC) or a network adapter for communicating with an Ethernet or other wired-based network or a wireless NIC or wireless adapter for communication with a wireless network, such as a WI-FI network. In one embodiment, bus 1406 includes hardware, software, or both coupling components of a computer system 1400 to each other.

While particular embodiments of the present invention have been described, it is understood that various different modifications within the scope and spirit of the invention are possible. The invention is limited only by the scope of the appended claims.

We claim:

1. A computer implemented method for predicting the geolocation of users in a social network, comprising:
receiving data on posts from a social network by a processor in operable communication with the social network;
identifying users on the social network using information data included in the posts;
identifying users with location information included in the posts and storing the location information for those users in a memory in operable communication with the processor;
identifying interactions between different users on the social network using the information data included in the posts;
determining an estimated location of a user whose posts do not include location information based on the user's interactions with other users on the social network; and
storing the estimated location of the user in the memory.

2. The method of claim 1, wherein identifying users with location information includes identifying posts of user's that contain latitude-longitude information.

3. The method of claim 1, wherein identifying users with location information includes identifying users who have self-reported their location.

4. The method of claim 2, wherein determining an estimated location for a user from a multitude of posts from that user containing latitude-longitude coordinates includes predicting a location from the multitude of posts.

5. The method of claim 4, wherein predicting a location includes determining a median of the coordinates.

6. The method of claim 5, further comprising determining a dispersion of the distances from the median for the coordinates.

7. The method of claim 6, further comprising generating a histogram of the distances from the median for the coordinates and identifying distinct peaks in the histogram.

8. The method of claim 5, further compromising generating a sorted array of the differences of the distances between the coordinates.

9. The method of claim 8, further compromising analyzing the sorted array and identifying clusters of locations.

10. The method of claim 9, further compromising determining values for a median and dispersion of each cluster.

11. The method of claim 1, wherein interactions between users are all treated equally.

12. The method of claim 1, wherein interactions between users are weighted differently depending on the type of interaction.

13. The method of claim 1, wherein interactions between users are weighted differently depending on the frequency of interaction between the users.

14. The method of claim 1 wherein a subset of interactions between users are selected for use in determining an estimated location of a user whose posts do not include location information.
